(19) United States
(12) Patent Application Publication
(10) Pub. No.: US 2015/0039174 A1
(43) Pub. Date: Feb. 5, 2015

(54) Vehicular Communication Device and Communication Management System

(71) Applicant: Hitachi Automotive Systems, Ltd., Hitachinaka-shi, Ibaraka (JP)

(72) Inventors: Kazuya Takahashi, Sagamihara-shi (JP); Tatsuyuki Yamamoto, Isehara-shi (JP)

(21) Appl. No.: 14/385,878

(22) PCT Filed: Mar. 7, 2013
(86) PCT No.: PCT/JP2013/056309

§ 371 Date: Sep. 17, 2014

(30) Foreign Application Priority Data
Mar. 22, 2012 (JP) 2012-066119

(51) Int. Cl. G07C 5/00; H04B 7/26

(52) U.S. Cl. CPC G07C 5/008; H04B 7/26
USPC 701/29.1

(57) ABSTRACT

Unique vehicle-identifying information, such as a VIN, for distinguishing or identifying a vehicle is stored in advance in a vehicle-identifying-information storing section. A vehicle-running-state information storing section collects and stores various pieces of vehicle-running-state information relevant to an operating state of airbag system and the like during a running of the vehicle. When a vehicle-abnormal-state detecting section detects an abnormality, a prioritizing section imparts a priority sequence in order of the vehicle-identifying information, information relevant to the operating state of airbag system, and the other vehicle-running-state information. Then, the prioritized information is promptly sent to a side of base station. Such a system configuration makes it possible to reliably send a minimum required amount of high-priority information necessary to identify the vehicle, such as the vehicle-identifying information, even in a situation that many vehicles are seriously damaged due to an accident, a disaster or the like.

### TECHNICAL FIELD

The present invention relates to a vehicular communication device and a communication management system, more particularly, relates to a vehicular communication device and a communication management system in which information for identifying a vehicle is preferentially sent to an outside in a case that some abnormal state occurs in the vehicle such as an accident of the vehicle.

### BACKGROUND ART

A system is proposed in which information (so-called probe information) relevant to running states of a plurality of running vehicles (so-called probe cars) is periodically collected in order to produce a road traffic information and improve its accuracy. Moreover, for example, Patent Literature 1 proposes a system in which an accident information of a running vehicle is reported to an outside in case that the running vehicle causes an accident.

In the system disclosed in Patent Literature 1, a collision (accident) of the vehicle is judged based on a signal of a collision-detection sensor of an airbag system mounted in the vehicle. Then, if it is determined that an accident has occurred, information of this accident and various kinds of information relevant to vehicle state memorized in a vehicle-information memorizing means are reported to an external communication center (base station) and the like through a mobile wireless communicating unit such as a cellular-phone unit and a car phone.

However, in the system disclosed in Patent Literature 1, a huge amount of data related to the vehicle state is sent concurrently with the accident information in order to inform a detailed situation of the accident when the accident has occurred. Hence, there is a risk that necessary information is unable to be sent when a serious disaster such as a large-scale earthquake has occurred, because there is a possibility that the communication is disrupted due to a communication complexity, a communication concentration, a communication failure or the like in a communication facility.

In particular, when a disaster which damages many vehicles all at once has occurred, there is a higher risk that the communication becomes impossible because the many vehicles try to send a large amount of information at the same time.

### CITATION LIST

### Patent Literature

Patent Literature 1: Japanese Patent Application Publication No. 2005-284666

### SUMMARY OF THE INVENTION

It is therefore an object of the present invention to provide a vehicular communication device and a communication management system, devised to send at least minimum necessary information which has a high priority such as a vehicle-identifying information necessary to identify a vehicle, to an outside, even under a situation that a plurality of vehicles incur serious damages by an accident, a disaster or the like.

A vehicular communication device according to the present invention comprises: a vehicle-abnormal-state detecting section mounted in a vehicle and configured to detect an abnormal state of the vehicle; a vehicle-information storage device in which a plurality of pieces of information relevant to the vehicle are stored; a prioritizing section configured to impart a priority order to the plurality of pieces of vehicle information stored in the vehicle-information storage device; and a mobile communicating unit provided in the vehicle and configured to send necessary information to an external receiving device. This mobile communicating unit is configured to send the vehicle information to the external receiving device, based on the priority order imparted after the vehicle-abnormal-state detecting section has detected the abnormal state.

According to the present invention, when the plurality of information pieces of the vehicle which were stored in the vehicle-information storage device are sent to the external receiving device, a priority order is given to the plurality of information pieces of the vehicle. By this priority order, the plurality of information pieces of the vehicle are sent to the external receiving device. Therefore, there is a high possibility that a high-priority information piece can be received by the receiving device even under a situation that complex communication, communication concentration, communication failure or the like is a concern.

### BRIEF EXPLANATION OF DRAWINGS

FIG. 1 A block circuit diagram illustrating a concrete embodiment of a vehicular communication device according to the present invention.

FIG. 2 A flowchart illustrating respective operating procedures in a vehicle side and a base station side of FIG. 1.

### DETAILED DESCRIPTION OF INVENTION

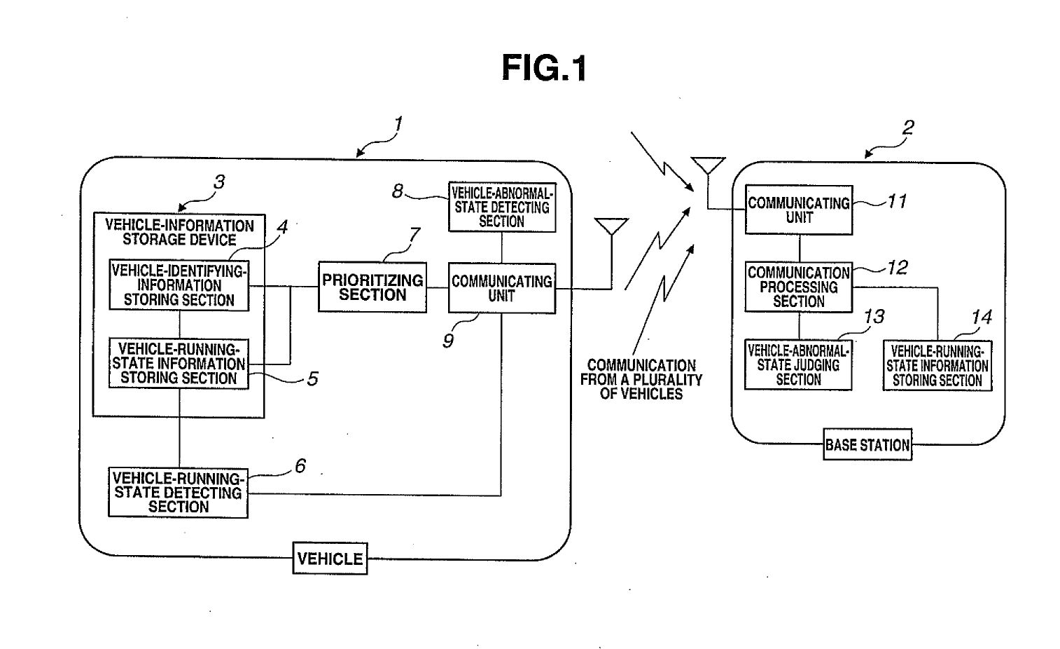

FIG. 1 is a functional block diagram schematically showing an embodiment of vehicular communication device and communication management system according to the present invention.

A system shown by FIG. 1 includes a vehicle (automobile) 1 and a base station 2. In this system, the base station 2 receives various kinds of information which are periodically sent from a plurality of vehicles 1, . . . , 1 by use of each communicating unit 9 provided for mobile wireless communication such as a cellular-phone, a smartphone and a car-phone.

The vehicle 1 (vehicle side) includes a vehicle-information storage device 3, a vehicle-running-state detecting section 6, a prioritizing section 7, a vehicle-abnormal-state detecting section 8 and the communicating unit 9. The vehicle-information storage device 3 includes a vehicle-identifying-information storing section 4 and a vehicle-running-state information storing section 5. As mentioned above, the communicating unit 9 is normally provided for the mobile wireless communication such as a cell-phone, a smartphone and a car-phone.

Unique vehicle-identifying information for identifying or distinguishing the vehicle 1 is registered and memorized in advance in the vehicle-identifying-information storing section 4 of the vehicle-information storage device 3, as one of vehicle information. This unique vehicle-identifying information is, for example, a VIN number (VIN code), a registration number of the vehicle, a chassis frame number and/or owner information. It is noted that the “VIN” stands for Vehicle Identification Number.

The vehicle-running-state detecting section 6 detects a running state of the vehicle during a running (moving) of the vehicle. For example, when the vehicle 1 is running, the vehicle-running-state detecting section 6 detects information relevant to the running state of the vehicle at predetermined intervals, through an ECU provided for controlling the vehicle 1 itself. The information relevant to the running state of the vehicle is, for example, a vehicle speed, a longitudinal acceleration (front-rear acceleration) of the vehicle 1, a side acceleration (right-left acceleration) of the vehicle 1, a manipulation amount of an accelerator pedal, a manipulation amount of a brake pedal, location information of the vehicle 1, and/or an operating state of an airbag. The various kinds of information relevant to the running state of the vehicle which are detected by the vehicle-running-state detecting section 6 are stored and accumulated in the vehicle-running-state information storing section 5 of the vehicle-information storage device 3 as a time-series data of the vehicle information.

The information stored in the vehicle-information storage device 3 constituted by the vehicle-identifying-information storing section 4 and the vehicle-running-state information storing section 5, i.e. the vehicle-identifying information and the various kinds of running-state information of the vehicle are collectively sent to the base station 2 at predetermined intervals (i.e. intermittently), by the communicating unit 9 provided for the mobile wireless communication. Every time the various kinds of running-state information of the vehicle finish being sent to the base station 2, the various kinds of running-state information of the vehicle which exist in the vehicle-running-state information storing section 5 are deleted.

The vehicle-abnormal-state detecting section 8 is monitoring the various kinds of running-state information of the vehicle which are detected by the vehicle-running-state detecting section 6 and stored in the vehicle-running-state information storing section 5. Thereby, for example, the vehicle-abnormal-state detecting section 8 detects an occurrence of abnormal state in the vehicle 1, such as an accident and a failure (malfunction) of the vehicle 1, based on an operating-state information of the airbag (e.g. ON/OFF signal of a sensor for sensing a collision) or the like.

When the abnormal state of the vehicle 1 occurs and is detected by the vehicle-abnormal-state detecting section 8, the prioritizing section 7 imparts or gives a priority order (priority sequence) to the various kinds of information which should be sent to the base station 2 at a next access timing. That is, the vehicle-identifying information existing in the vehicle-identifying-information storing section 4 of the vehicle-information storage device 3 and the vehicle-running-state information existing in the vehicle-running-state information storing section 5 are sent at the predetermined intervals from the vehicle 1 to the base station 2, as mentioned above. In this regard, the vehicle-running-state information existing in the vehicle-running-state information storing section 5 has a much larger information volume (size) than a volume of the vehicle-identifying information existing in the vehicle-identifying-information storing section 4. Therefore, the priority order is set among the various kinds of information which are scheduled to be sent to the base station 2 at the next access timing. By using this priority order, the various kinds of information are sent at the next access timing.

In the case that an accident, a failure or the other abnormal state happens to the vehicle 1 and is detected by the vehicle-abnormal-state detecting section 8; for example, the prioritizing section 7 assigns a first-order priority to the unique vehicle-identifying information for identifying or distinguishing the vehicle 1, and assigns a second-order priority to the operating-state information of the airbag, and assigns a third-order priority to the other kinds of information. Such a priority order is set in advance among the various kinds of information which should be sent from the vehicle 1 to the base station 2, in this embodiment. The communicating unit 9 sends predetermined information which has a communication data format based on this priority order, to the base station 2.

On the other hand, the base station 2 (base-station side) includes a communicating unit 11, a communication processing section 12, a vehicle-abnormal-state judging section 13 and a vehicle-running-state information storing section 14. The communicating unit 11 can communicate with the communicating units 9 provided to the plurality of vehicles 1 for mobile wireless communication. This communicating unit 11 of the base station 2 may be constructed as a receiver which can only receive at least the various kinds of information sent from the respective vehicles 1. However, of course, the communicating unit 11 may be constructed as a transceiving unit which can perform a bidirectional (two-way) communication. Respective hardware itself which constitutes the base station 2 is constructed as a general computer system. For example, a function as a server and a function as a host computer in the base station 2 may be furnished by substantially one computer system.

The communicating unit 11 of the base station 2 receives information sent from the communicating unit 9 of the vehicle 1, i.e. receives the vehicle-identifying information and the vehicle-running-state information, at access timings which are set at predetermined intervals. Every time the communicating unit 11 receives the information sent from the vehicle 1, the communication processing section 12 performs a necessary preprocessing. Specifically, if any information relevant to the abnormal state of the vehicle is not included in the information received from the vehicle 1, the communication processing section 12 determines that this reception from the vehicle 1 is a normal-time reception. Then, the communication processing section 12 stores (memorizes) and accumulates the received information, i.e. the vehicle-identifying information and the vehicle-running-state information, in the vehicle-running-state information storing section 14 as a time-series data.

On the other hand, if certain information relevant to the abnormal state of the vehicle is included in the information received from the vehicle 1, the vehicle-abnormal-state judging section 13 identifies or finds the vehicle 1 which is actually in the abnormal state on the basis of the received vehicle-identifying information. At the same time, the vehicle-abnormal-state judging section 13 judges (estimates) whether the identified vehicle 1 has caused a collision accident, a failure or the other vehicle abnormality, on the basis of the received vehicle-running-state information.

In such a case, even if the communicating unit 11 of the base station 2 has failed to receive all of the information scheduled to be received, due to a communication error caused in middle of the communication between the communicating unit 11 and the vehicle 1; the communicating unit 11 treats some information which has already been received before the communication error (i.e. a part of all the information), as a valid information. Hence, in case that the communication from the vehicle 1 to the base station 2 is disrupted, the vehicle-identifying information which has a high priority among the various kinds of information having the priority order given at the time of sending has a high probability of being received by the base station 2. Therefore, the vehicle 1 which has become in the abnormal state has a high likelihood of being promptly identified (found).

In this embodiment, if the communicating unit 11 of the base station 2 has received at least the vehicle-identifying information although the communicating unit 11 has failed to receive all of the information scheduled to be received, a background (development) of occurrence of the accident or abnormality is estimated from the vehicle-running-state information sent by this vehicle 1 immediately before the communication error, i.e. from the time-series data already sent at the time of normal (not-failed) state. For example, the vehicle-abnormal-state judging section 13 gets access to the vehicle-running-state information storing section 14. Thereby, the vehicle-abnormal-state judging section 13 estimates that the vehicle 1 has sent the information of the abnormal state because the airbag was activated due to the occurrence of a collision accident, in a case that a previous data (last-time-around data) of the longitudinal acceleration G of the vehicle includes a record of great deceleration.

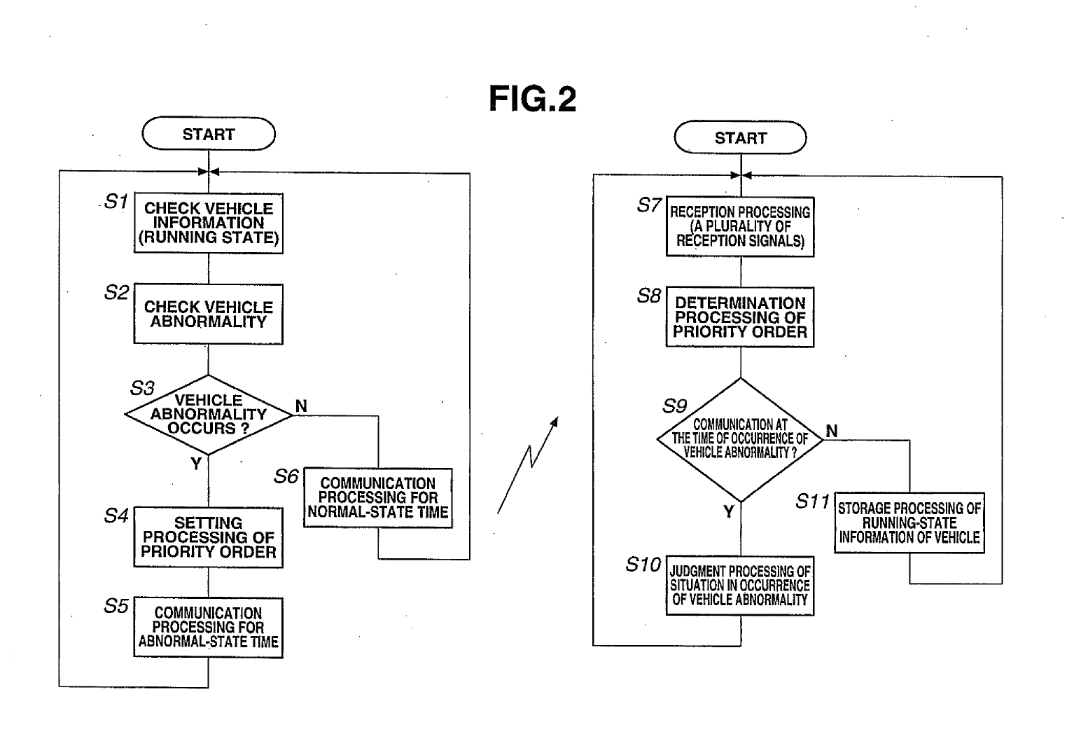

FIG. 2 shows a series of handling procedures in the system shown by FIG. 1.

The vehicle 1 (vehicle side) repeatedly executes a process of steps S1 to S6 of FIG. 2, at predetermined intervals.

At step S1, the vehicle-running-state detecting section 6 shown in FIG. 1 checks the running state of the vehicle 1 during the running of the vehicle 1. Then, the vehicle-running-state detecting section 6 detects and obtains the vehicle-running-state information (driving-state information) of the vehicle 1, such as the vehicle speed, the longitudinal and side accelerations of the vehicle 1, the manipulation amount of the accelerator pedal, the manipulation amount of the brake pedal, a manipulation amount of a steering wheel, and the operating state of the airbag. Then, the vehicle-running-state detecting section 6 stores the obtained vehicle-running-state information in the vehicle-running-state information storing section 5 of the vehicle-information storage device 3 shown in FIG. 1.

At step S2, the vehicle-abnormal-state detecting section 8 checks the obtained various kinds of vehicle-running-state information. Particularly at step S3, the vehicle-abnormal-state detecting section 8 detects and determines whether the vehicle 1 is in the abnormal state such as an accident and a failure of the vehicle 1, on the basis of the operating state of the airbag system or the like.

If the abnormal state of the vehicle 1 is not detected, a communication processing for the normal state (normal-state time) is executed at step S6. That is, at step S6, the various kinds of vehicle-running-state information existing in the vehicle-running-state information storing section 5 and the vehicle-identifying information existing in the vehicle-identifying-information storing section 4 are sent to the base station 2. It is noted that the vehicle-running-state information which exists (i.e., was stored) in the vehicle-running-state information storing section 5 is deleted every time this vehicle-running-state information has been correctly sent to the base station 2.

If any abnormal state of the vehicle 1 is detected when the vehicle-abnormal-state detecting section 8 has checked the various kinds of vehicle-running-state information at steps S2 and S3 as mentioned above, the prioritizing section 7 imparts the priority order to the information which should be sent to the base station 2, at step S4. The information which should be sent from the vehicle 1 to the base station 2 is the vehicle-identifying information existing in the vehicle-identifying-information storing section 4 and the vehicle-running-state information stored in the vehicle-running-state information storing section 5. As mentioned above, the first priority is assigned to the unique vehicle-identifying information for identifying or distinguishing the vehicle 1, the second priority is assigned to the operating-state information of the airbag, and the third priority is assigned to the other kinds of information.

At step S5, as a communication processing for the abnormal state (abnormal-state time), the communicating unit 9 provided for mobile wireless communication of the vehicle 1 sends the necessary information to the base station 2 in a communication data format based on the imparted priority order.

On the other hand, the base station 2 repeatedly executes a process of steps S7 to S11 of FIG. 2 at predetermined intervals.

At step S7 of FIG. 2, the base station 2 performs a reception processing for the various kinds of necessary information derived from each vehicle 1. This reception processing is performed regardless whether the various kinds of necessary information derived from each vehicle 1 are information sent by the normal-state-time communication processing of step S6 or information sent by the abnormal-state-time communication processing of step S5. Such information received from the plurality of vehicles 1 is temporarily stored in a buffer (not shown). Then, the following process is conducted in a predetermined sequence among the stored information of the buffer.

At step S8 of FIG. 2, the communication processing section 12 of FIG. 1 checks a content of the reception data temporarily stored in the buffer, and determines a priority order for the processing of this reception data. If any vehicle information sent as the abnormal-state-time sending processing exists in the information received from the plurality of vehicles 1, i.e., if any information indicating the abnormal state of the vehicle 1 is included in the information received from the plurality of vehicles 1, then a high priority for the processing is given to the information indicating the abnormal state of the vehicle 1 (i.e. given to all information derived from the abnormal-state vehicle 1).

Moreover, if the information sent as the abnormal-state-time sending processing is derived from multiple vehicles, a priority order for the processing among the respective pieces of information derived from these multiple vehicles is set in order of receipt time. In the same manner, if the information sent as the normal-state-time sending processing is derived from multiple vehicles, a priority order for the processing among the respective pieces of information derived from these multiple vehicles is set in order of receipt time.

At step S9, the vehicle-abnormal-state judging section 13 of FIG. 1 checks a content of the information piece of the highest-priority vehicle among the information of the plurality of vehicles which has been accumulated in the buffer. If the information piece of the highest-priority vehicle does not include information indicating the abnormal state of vehicle, i.e. was sent as the normal-state-time sending processing, then the program proceeds to step S11. At step S11, as a vehicle-running-state information storing processing, the running-state information of the highest-priority vehicle is stored and accumulated as a time-series data in the vehicle-running-state information storing section 14 of FIG. 1.

On the other hand, as a result of the judgment of the vehicle-abnormal-state judging section 13 of step S9, if it is determined that the information piece of the highest-priority vehicle includes information indicating the abnormal state of vehicle, i.e. was sent as the abnormal-state-time sending processing, then the program proceeds to step S10. At step S10, the vehicle-abnormal-state judging section 13 of FIG. 1 analyses the received vehicle-running-state information. Thereby, the vehicle-abnormal-state judging section 13 identifies the vehicle which has the abnormal state such as the accident or failure, from the vehicle-identifying information. In addition to this, the vehicle-abnormal-state judging section 13 identifies an occurrence situation of the abnormal state such as the accident or failure. Moreover, the vehicle-abnormal-state judging section 13 determines or estimates an occurrence background (cause) of the abnormal state of this vehicle 1 such as a background of accident outbreak, by referring also to the normal-state-time information received from this vehicle 1 and stored in the vehicle-running-state information storing section 14 before the occurrence of the abnormal state of this vehicle 1. Therefore, the vehicle-abnormal-state judging section 13 of FIG. 1 functions also as a vehicle-abnormal-state estimating means.

Afterward, the base station 2 reports the above-mentioned judgment result and its vehicle-identifying information to predetermined agencies such as a police station, a fire department, an accident rescue service center, an insurance company and/or a preregistered emergency contact person.

According to the system of the above embodiment, when the plurality of information pieces of the vehicle which were stored in the vehicle-information storage device are sent to an external receiving device, a priority order is given to the plurality of information pieces of the vehicle. By this priority order, the plurality of information pieces of the vehicle are sent to the external receiving device. Therefore, there is a high possibility that a high-priority information piece can be received by the receiving device even under a situation that complex communication, a communication concentration, communication failure or the like is a concern.

Effects according to respective claims are as follows.

According to the invention recited in claim 5, the vehicle-information storage device includes the vehicle-running-state information storing section configured to memorize information relevant to the running state of a vehicle during a running of the vehicle, and the vehicle-abnormal-state detecting section is configured to detect an accident or failure of the vehicle as the abnormal state of the vehicle on the basis of the information memorized by the vehicle-running-state information storing section. Therefore, the accident or the failure can be identified based on the running state.

According to the invention recited in claim 7, the mobile communicating unit is configured to intermittently send information. Hence, the sending and receiving of information can reawake even after a communication error occurred.

According to the invention recited in claim 8, the vehicular communication device includes the vehicle-abnormal-state detecting section mounted in the vehicle and configured to detect an abnormal state of the vehicle; the vehicle-information storage device in which a plurality of pieces of information relevant to the vehicle are stored; the prioritizing section configured to impart a priority order to information pieces necessary to be sent to an external which are included in the plurality of pieces of vehicle information stored in the vehicle-information storage device, after the vehicle-abnormal-state detecting section has detected the abnormal state of the vehicle; and the mobile communicating unit provided in the vehicle and configured to send necessary information to an external receiving device. Hence, when the abnormality occurs, high-priority information can be promptly transmitted to the external.

According to the invention recited in claim 9, the mobile communicating unit is provided in the vehicle (vehicle side) and configured to send the information pieces to the external receiving device in the priority order imparted by the prioritizing section. Hence, high-priority information can be transmitted to the external in a short time.

According to the invention recited in claim 10, the unique vehicle-identifying information for identifying the host vehicle exists in the vehicle-information storage device as a part of the plurality of pieces of vehicle information, and the prioritizing section is configured to assign a highest priority to the vehicle-identifying information. Hence, the vehicle can be identified quickly.

According to the invention recited in claim 11, the unique vehicle-identifying information for identifying the host vehicle exists in the vehicle-information storage device as a part of the plurality of pieces of vehicle information, and the prioritizing section is configured to assign a highest priority to at least predetermined one of the plurality of pieces of vehicle information. Hence, most necessary information can be promptly transmitted.

According to the invention recited in claim 12, the mobile communicating unit is configured to send the vehicle information when the vehicle-abnormal-state detecting section detects the abnormal state of the vehicle. Hence, the vehicle can be identified at the time of occurrence of abnormal state of that vehicle.

According to the invention recited in claim 13, the mobile communicating unit is configured to intermittently send information. Hence, the sending and receiving of information can become available even after a communication error occurred.

According to the invention recited in claim 14, the vehicle-information storage device includes the vehicle-running-state information storing section configured to memorize information relevant to a running state of the vehicle during a running of the vehicle, and the vehicle-abnormal-state detecting section is configured to detect an accident or failure of the vehicle as the abnormal state of the vehicle on the basis of the information memorized by the vehicle-running-state information storing section. Hence, the accident or the failure can be identified based on the running state of the vehicle.

According to the invention recited in claim 15, the communication management system includes memorizing means for memorizing information relevant to a running state of a vehicle, that is provided to a mobile object which is the vehicle or a driver; the mobile communicating unit configured to send the information memorized by the memorizing means; and the receiving device configured to receive the information sent from the mobile communicating unit, wherein the mobile communicating unit includes vehicle-abnormal-state detecting means for detecting an abnormal state of the vehicle, and prioritizing means for giving a priority order to the information memorized by the memorizing means, wherein the mobile communicating unit is configured to send information to the receiving device on the basis of the priority order given after the abnormal state of the vehicle is detected by the vehicle-abnormal-state detecting means, wherein the receiving device includes vehicle-abnormal-state estimating means for estimating the abnormal state of the vehicle on the basis of the received information. Hence, the abnormal state of the vehicle can be promptly estimated, so that such information can be effectively used.

According to the invention recited in claim 16, the receiving device is provided in the communication base station. Hence, necessary information can be received at a distant place, and thereby effectively used at the distant place.

According to the invention recited in claim 17, the mobile communicating unit is configured to send the information when the abnormal state of the vehicle is detected by the vehicle-abnormal-state detecting means. Hence, the abnormal state can be immediately recognized.

According to the invention recited in claim 18, the receiving device is configured to process the information sent by the mobile communicating unit in priority to a processing based on the other information. Hence, the information indicating the abnormal state is preferentially processed to improve a convenience.

According to the invention recited in claim 19, the mobile communicating unit is configured to send the information when the abnormal state of the vehicle is detected by the vehicle-abnormal-state detecting section. Hence, the abnormal state of the vehicle can be promptly estimated, so that such information can be effectively used.

According to the invention recited in claim 20, the mobile communicating unit is configured to intermittently send information. Hence, the sending and receiving of information can become available even after a communication error occurred.

1. A vehicular communication device comprising:
a vehicle-abnormal-state detecting section mounted in a vehicle and configured to detect an abnormal state of the vehicle;
a vehicle-information storage device in which a plurality of pieces of information relevant to the vehicle are stored, wherein the plurality of pieces of information relevant to the vehicle has a unique vehicle-identifying information for identifying the vehicle;
a prioritizing section configured to impart a priority order to the plurality of pieces of vehicle information stored in the vehicle-information storage device, and configured to assign a highest priority to the vehicle-identifying information; and
a mobile communicating unit provided in the vehicle and configured to send necessary information to an external receiving device,
wherein the mobile communicating unit is configured to send the vehicle information to the external receiving device, based on the priority order imparted after the vehicle-abnormal-state detecting section has detected the abnormal state.

2. (canceled)

3. The vehicular communication device according to claim 1, wherein
the mobile communicating unit is configured to send the vehicle information including the vehicle-identifying information when the vehicle-abnormal-state detecting section detects the abnormal state of the vehicle.

4. The vehicular communication device according to claim 1, wherein
the prioritizing section is configured to assign a highest priority to at least predetermined one of the plurality of pieces of vehicle information.

5. The vehicular communication device according to claim 1, wherein
the vehicle-information storage device includes a vehicle-running-state information storing section configured to memorize information relevant to a running state of the vehicle during a running of the vehicle, and
the vehicle-abnormal-state detecting section is configured to detect an accident or failure of the vehicle as the abnormal state of the vehicle on the basis of the information memorized by the vehicle-running-state information storing section.

6. The vehicular communication device according to claim 4, wherein
the vehicle-information storage device includes a vehicle-running-state information storing section configured to memorize information relevant to a running state of the vehicle during a running of the vehicle, and
the vehicle-abnormal-state detecting section is configured to detect an accident or failure of the vehicle as the abnormal state of the vehicle on the basis of the information memorized by the vehicle-running-state information storing section.

7. The vehicular communication device according to claim 1, wherein
the mobile communicating unit is configured to intermittently send information.

8. A vehicular communication device comprising:
a vehicle-abnormal-state detecting section mounted in a vehicle and configured to detect an abnormal state of the vehicle;
a vehicle-information storage device in which a plurality of pieces of information relevant to the vehicle are stored, wherein the plurality of pieces of information relevant to the vehicle has a unique vehicle-identifying information for identifying the vehicle;
a prioritizing section configured to impart a priority order to information pieces necessary to be sent to an external which are included in the plurality of pieces of vehicle information stored in the vehicle-information storage device such that a highest priority is assigned to the vehicle-identifying information, after the vehicle-abnormal-state detecting section has detected the abnormal state of the vehicle; and
a mobile communicating unit provided in the vehicle and configured to send information to an external receiving device in the priority order imparted by the prioritizing section.

9. (canceled)

10. (canceled)

11. The vehicular communication device according to claim 8, wherein
the prioritizing section is configured to assign a highest priority to at least predetermined one of the plurality of pieces of vehicle information.

12. The vehicular communication device according to claim 8, wherein
the mobile communicating unit is configured to send the vehicle information when the vehicle-abnormal-state detecting section detects the abnormal state of the vehicle.

13. The vehicular communication device according to claim 8, wherein
the mobile communicating unit is configured to intermittently send information.

14. The vehicular communication device according to claim 8, wherein
the vehicle-information storage device includes a vehicle-running-state information storing section configured to memorize information relevant to a running state of the vehicle during a running of the vehicle, and
the vehicle-abnormal-state detecting section is configured to detect an accident or failure of the vehicle as the abnormal state of the vehicle on the basis of the information memorized by the vehicle-running-state information storing section.

15. A communication management system comprising:
memorizing means for memorizing information relevant to a running state of a vehicle, the memorizing means being provided to a mobile object which is the vehicle or a driver;
a mobile communicating unit configured to send the information memorized by the memorizing means; and
a receiving device configured to receive the information sent from the mobile communicating unit,
wherein the mobile communicating unit includes
vehicle-abnormal-state detecting means for detecting an abnormal state of the vehicle, and
prioritizing means for giving a priority order to the information memorized by the memorizing means,
wherein the mobile communicating unit is configured to send information to the receiving device on the basis of the priority order given after the abnormal state of the vehicle is detected by the vehicle-abnormal-state detecting means,
wherein the receiving device includes
vehicle-abnormal-state estimating means for estimating the abnormal state of the vehicle on the basis of the received information,
wherein the receiving device is configured to process the information sent by the mobile communicating unit in priority to a processing based on the other information.

16. The communication management system according to claim 15, wherein
the receiving device is provided in a communication base station.

17. The communication management system according to claim 16, wherein
the mobile communicating unit is configured to send the information when the abnormal state of the vehicle is detected by the vehicle-abnormal-state detecting means.

18. (canceled)

19. The communication management system according to claim 15, wherein
the mobile communicating unit is configured to send the information when the abnormal state of the vehicle is detected by the vehicle-abnormal-state detecting.

20. The communication management system according to claim 15, wherein
the mobile communicating unit is configured to intermittently send information.
